(19) United States
(12) Patent Application Publication
(10) Pub. No.: US 2004/0086121 A1
(43) Pub. Date: May 6, 2004

(54) Secure automatic dependant surveillance

(75) Inventors: Marc J. Viggiano, Manlius, NY (US); Edward M. Valovage, Memphis, NY (US); Marcello Distasio, Syracuse, NY (US)

Correspondence Address: Stephen B. Salai, Esq., Harter, Secrest & Emery LLP, 1600 Bausch & Lomb Place, Rochester, NY, 14604-2711, US

(73) Assignee: Sensis Corporation, DeWitt, NY

(21) Appl. No.: 10/285,070

(22) Filed: Oct. 31, 2002

(51) Int. Cl. H04L 9/00

(52) U.S. Cl. 380/255; 713/168

(57) ABSTRACT

A secure automatic dependant surveillance—broadcast system includes: an authenticator including a unique id generator memory storing an authenticator secret key and a transmitter for transmitting the unique id to a responder; a responder including a secure hash algorithm generator combining the received unique id with a responder secret key and a data signal to generate a secure response and a transmitter transmitting the secure response and the data signal to the authenticator; the interrogator also including a receiver receiving the secure response and the data; the authenticator including an secure hash algorithm generator combining the received data and the received secure response and generating an output signal; and a comparator for comparing the output signal with the received secure response and providing an authentication signal based on the comparison.

### FIELD OF THE INVENTION

This pertains to the general area of ADS-B (Automatic Dependent Surveillance—Broadcast, a field of aviation surveillance) and in particular to a method for authenticating ADS-B reports and for making them tamper-resistant.

### BACKGROUND OF THE INVENTION

ADS-B is a technology which is being developed and deployed around the world to enhance aviation safety by allowing aircraft to make accurate and timely reports of their position, velocity, identification, capability, and intentions. The system is, however, vulnerable to corruption from intentional false reports (called “attacks”.) Existing ADS-B is not secure. Transponders can be disabled, the protocol lacks authentication, it is subject to spoofing and replay attacks, and the plaintext broadcast of position can be exploited. Known alternatives do not solve these problems. GPS is subject to intentional and unintentional interference. Black Box data is difficult to locate and not timely. Many instances of damaged or lost black box recorders are known. Immediate (real time) access to flight and voice could prevent some disasters.

This invention addresses these and other problems by employing cryptographic techniques to enhance basic ADS-B and provide additional security. The secure ADS-B link of this invention can be used for real time emergency downlink of flight & Voice Data. The Mode-S datalink can be used to accommodate an emergency downlink.

It is an advantage of this invention that the data and ID are protected during transfer since any change will result in a failed comparison.

Physical security for the user and secret keys can be provided by providing fixed unreadable storage, and/or daily or periodic updating.

Preferably, each user/aircraft is provided with a different secret key to prevent system wide loss of security. The separate keys can be generated by a secure key generation from a unique ID and a master secret key.

### BRIEF DESCRIPTION OF THE INVENTION

A secure automatic dependant surveillance—broadcast system in accordance with this invention includes: an authenticator including a unique id generator memory storing an authenticator secret key and a transmitter for transmitting the unique id to a responder; a responder including a secure hash algorithm generator combining the received unique id with a responder secret key and a data signal to generate a secure response and a transmitter transmitting the secure response and the data signal to the authenticator; the interrogator also including a receiver receiving the secure response and the data; the authenticator including an secure hash algorithm generator combining the received data and the received secure response and generating an output signal; and a comparator for comparing the output signal with the received secure response and providing an authentication signal based on the comparison.

### BRIEF DESCRIPTION OF THE DRAWINGS

FIG. 1 is a block diagram of a secure ADS-B system in accordance with the invention.

### DETAILED DESCRIPTION OF THE PREFERRED EMBODIMENT

This invention applies the field of data authentication to the field of ADS-B. In this method, an aircraft which is reporting its position to a ground or airborne receiver is periodically “challenged” by the receiver to authenticate itself. It does so with a “response” or “handshake” which depends on a secret key that is stored in memory in the aircraft and in the authenticator. An attacker who does not know the secret key is unable to give the appropriate response to the challenge, and the report can be considered unauthentic.

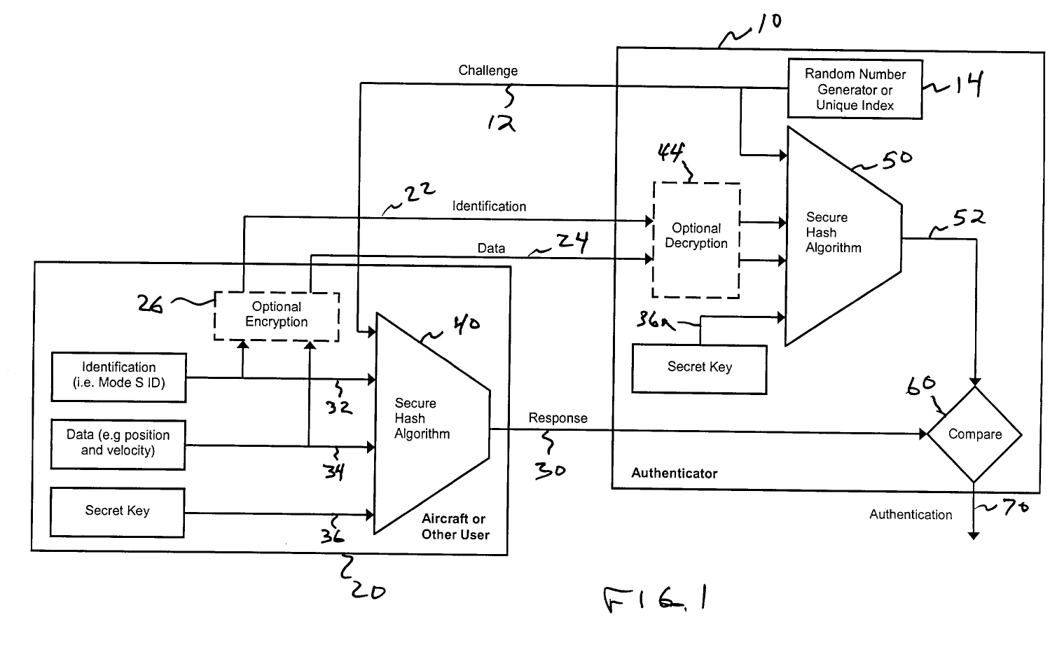

In FIG. 1, the challenge 12 from the interrogator/authenticator 10 begins the process. The challenge signal contains an indentifier or is in the necessary format to indicate that it is a challenge, and in addition it has a data field generated by generator 14 which is different with every challenge. This data field can be but need not be random. It need only be unique so that an attacker cannot “learn” a valid response. The aircraft or other user 20 replies with its ID 22 and data 24 which may include such data as position, velocity, intended action as might be provided by a flight management system, and which may be encrypted by encryptor 26 or other means or sent in-the-clear. In addition, the reply or response 30 combines the ID 32, data 34, the challenge contents 12, and the secret key 36 combined in a secure hash algorithm by generator 40 which may be implemented in hardware of software. The interrogator 10 receives the ID and data, decrypts in decryptor 44 it if it was encrypted, and combines it locally with the challenge contents 12 and the same secret key 36a in the hash algorithm generator 50. The locally generated hashed signal 52 and the response 30 are applied to comparator 60. If the response from the aircraft matches the locally generated result, an authentication signal 70 is produced indicating that the aircraft is authenticated.

Physical security for the secret key can be provided in several ways. The secret key can be fixed and unreadable, i.e. never transmitted over any system. It can be updated periodically via transmission over a secure medium. If there are multiple users being authenticated, the secret key used in the hash algorithm should be different for each user. This helps protect the system from a system wide attack. This protection can still be achieved with a common “master” secret key by using a key generation algorithm which generates unique secret keys from a unique ID plus the master secret.

This secure ADS-B technique does not depend on any one specific secure hash algorithm. Some secure hash algorithms have response hashes that are longer than the standard ADS-B message size. These long responses may be necessary in order to provide the desired level of security. This problem can be overcome by spreading the response over several ADS-B messages. In this case, a response sequence number can be used to indicate what part of the response is represented by each of the multiple messages. If the authenticator receives all parts of the response and reassembles the response, and if it passes the comparison check, the data in all messages is authenticated. If any response message is missed, this fact will be known because of the encoded sequence number. In this case, the challenge can be retried.

While the invention has been described in connection with a presently preferred embodiment thereof, those skilled in the art will appreciate that various modifications and changes may be made therein without departing from the true spirit and scope of the invention which is accordingly intended to be limited solely by the appended claims.

1. A secure automatic dependant surveillance—broadcast system comprising:
(a) an authenticator including a unique id generator memory storing an authenticator secret key and a transmitter for transmitting the unique id to a responder;
(b) a responder including a secure hash algorithm generator combining the received unique id with a responder secret key and a data signal to generate a secure response and a transmitter transmitting the secure response and the data signal to the authenticator;
(c) the interrogator also including a receiver receiving the secure response and the data;
(d) the authenticator including an secure hash algorithm generator combining the received data and the received secure response and generating an output signal; and a comparator for comparing the output signal with the received secure response and providing an authentication signal based on the comparison.

2. A method of secure automatic dependant surveillance between an
(a) authenticator and an aircraft comprising:
(b) generating a unique ID in the authenticator;
(c) transmitting the unique ID to the aircraft;
(d) combining the received unique ID and a data signal and an aircraft secret key in a secure hash algorithm in the aircraft to generate an aircraft secure response;
(e) transmitting the data signal and the aircraft secure response to the authenticator;
(f) combining the unique id, the received data signal, and an authenticator secret key in a secure hash algorithm in the authenticator to produce an authenticator secure response; and
(g) comparing the authenticator secure response and the received secure response and generating an authentication signal depending on the results of the comparison.

3. The method of claim 2 comprising transmitting an identifying signal from the aircraft to the authenticator, and combining the identification signal with the received unique ID and the data signal and the aircraft secret key in the secure hash algorithm in the aircraft to generate the aircraft secure response, and combining the received identification signal with the authenticator unique ID and the received data signal and the authenticator secret key in the secure hash algorithm in the authenticator to generate the authenticator secure response.

4. The method of claim 2 comprising encrypting the data signal in the aircraft before transmitting to the authenticator, and decrypting the received data signal in the authenticator before applying it to the authenticator secure hash algorithm.

5. The method of claim 3 comprising encrypting the data signal and the identifying signal in the aircraft before transmitting them to the authenticator, and decrypting the received data signal and the received identifying signal in the authenticator before applying them to the authenticator secure hash algorithm.

6. The method of claim 2 in which the authenticator secret key and the aircraft secret key are the same.
